(19) United States
(12) Patent Application Publication
(10) Pub. No.: US 2003/0190065 A1
(43) Pub. Date: Oct. 9, 2003

(54) Fast iterative image reconstruction from linograms

(75) Inventors: James J. Hamill, Knoxville, TN (US); Christian J. Michel, Lenoir City, TN (US)

Correspondence Address: PITTS AND BRITTIAN P C, P O BOX 51295, KNOXVILLE, TN, 37950-1295, US

(73) Assignee: CTI PET Systems, Inc., Knoxville, TN

(21) Appl. No.: 10/397,597

(22) Filed: Mar. 26, 2003

Related U.S. Application Data
(60) Provisional application No. 60/367,658, filed on Mar. 26, 2002.

(51) Int. Cl. G01T 5/00

(52) U.S. Cl. 382/131

(57) ABSTRACT

A method for performing accurate iterative reconstruction of image data sets based on Approximate Discrete Radon Transformation (ADRT). ADRT and its inverse are implemented to provide exactly matched forward and backward projectors suitable for the Maximum-Likelihood Expectation-Maximization (ML-EM) reconstruction in PET. A 2D EM reconstruction algorithm is accomplished by initializing an estimation image. A back projection of the projection weights is then formed. A loop is begun with a controlled number of iterations. The estimated image is then forward projected using linogram coordinates. A correction ratio linogram is formed and correction factors are back projected. A normalization factor is then applied. This 2D EM method is extendable into 3D reconstructions using 3D PET lines of response. Forward projection is performed on planes extracted from the image voxels. Back projection is also performed in 2D planes, which are subsequently added into the 3D array with the correct orientations.

### CROSS-REFERENCE TO RELATED APPLICATIONS

This application claims the benefit of U.S. Provisional Application No. 60/367,658, filed Mar. 26, 2002.

### STATEMENT REGARDING FEDERALLY SPONSORED RESEARCH OR DEVELOPMENT

Not Applicable

### BACKGROUND OF THE INVENTION

1. Field of Invention

The present invention pertains to the field of medical image reconstruction. More particularly, this invention is an iterative reconstruction method using linograms for use in clinical settings such as in two- and three-dimensional Positron Emission Tomography.

2. Description of the Related Art

In the field of positron emission tomography (PET), it is well known that image reconstruction requires the projection of thousands or millions of discrete values from one computer array into another. These procedures are time-consuming in statistical reconstruction, where iterative algorithms are used.

Until recent years, iterative reconstruction has been considered too slow for clinical use. However, with faster computers, the development of acceleration techniques such as ordered subsets, and the development of Fourier rebinning for transforming 3D PET sinograms into 2D sinograms, iterative reconstruction has become clinically feasible. However, even with these improvements in the art, the run time for reconstruction calculations remains longer than desired.

Applied mathematics provides a number of acceleration techniques for this situation, including techniques based on recursive “butterfly” algorithms. Butterfly algorithms decompose required sums into a collection of partial sums, which are used repeatedly in the full calculation. Perhaps the best-known butterfly algorithm is the fast Fourier transform (FFT), which allows one to efficiently calculate discrete Fourier transforms, which is a key step in analytic tomographic reconstruction. A number of analytic reconstruction techniques are fast because they use FFTs in conjunction with the Central Slice Theorem, replacing two-dimensional back-projections with a set of one-dimensional FFTs, followed by a one-dimensional interpolation in frequency space, and finally a single two dimensional inverse FFT back to the image domain. See, H. Stark et al., “Investigation of computerized tomography by direct Fourier inversion and optimum interpolation,” IEEE Trans. Biomed. Eng., vol. BME-28, no. 7, pp. 496-1331, July 1981.

This technique has also been applied in three-dimensional filtered-back-projection reconstruction based on a planogram representation for the projections. This application is described in D. Brasse et al., “Fast fully 3D image reconstruction using planograms,” Conference Record of the IEEE Nuclear Science Symposium and Medical Imaging Conference, Lyon, France, 2000, vol. 2, pp. 15/239-15/243, October, 2000. Three and four-dimensional FFTs were used. In that work, a role was proposed for FFTs in iterative reconstruction. However, a fundamental difficulty arises, that being that the iterative algorithms require comparisons with the measured projections, so multidimensional FFTs have to be exercised at each iteration. The speed advantage is reduced, (see D. Brasse et al., “Using Planogram Coordinates,” Conference Record of the IEEE Nuclear Science Symposium and Medical Imaging Conference, Norfolk, Va., 20021 especially when one attempts to accelerate the convergence by using ordered subsets of the projections. See H. M. Hudson et al., “Accelerated image reconstruction using ordered subsets of projection data,” IEEE Trans. Med. Im. vol. 13, no. 4, p 601-609, December 1994.

Two other acceleration techniques using butterfly algorithms have been proposed for analytic reconstruction. One of these techniques, called “fast back-projection” performs back projections of sinograms or linograms by operating along links between projection bins. This is as disclosed by P. E. Danielsson et al., “Backprojection in O(N²logN) time,” Conference Record of the IEEE Nuclear Science Symposium and Medical Imaging Conference, Albuquerque, N. Mex., paper M7-27 on CD, November, 1997.

Another technique is the Approximate Discrete Radon Transform (ADRT), as disclosed by M. L. Brady, “A fast discrete approximation algorithm for the Radon transform,” SIAM J. Comput., Vol. 27, no 1, p 107-119, February 1998. The ADRT butterfly algorithm makes p passes through the rows of a matrix with the number of rows (N) determined by N=2^{P}. A strip-integral model is used, with nearest-neighbor interpolation in each pass, to generate linogram projections very rapidly. However, it is known that the nearest-neighbor interpolations are not sufficiently accurate for CT image reconstruction. See, M. Ingerhed, “Fast backprojection for computed tomography,” LIU-TEK-LIC-1999:17, Department of Electrical Engineering, Linköping University, Sweden, pp. 43-44, April 1999.

The core algorithm taught by Brady projects gridded values onto strips of fixed width δx on a horizontal axis, where δx is the spacing between points in the grid. The number of rows in the grid must be a power of 2. For explanation, assume the number of rows is N_{Y}. The algorithm generates projections at N_{Y} angles between 0 and π/4 radians, namely,

$${φ}_{i} = arctan \frac{i}{{N}_{Y} - 1} ,$$

where the direction of integration ranges from vertical to π/4 radians counter-clockwise from vertical. The symbol v is used to indicate the tangent itself:

$$v = \frac{i}{{N}_{Y} - 1} .$$

The ADRT algorithm works by integrating across strips whose width in the grid is proportional to cos φ. Specifically, the ADRT algorithm provides samples of

ADRT(u,v)≈path integral×cos φ.

The equation relating an image f_{x,y} to a linogram L_{u,v} through the ADRT projector A is

$${P}_{u , v} = \frac{A {\{ {f}_{x , y} \}}_{u , v}}{1 + {v}^{2}} .$$

The goal of tomography is to reconstruct an object from its measured projections. In 2D, the image is commonly represented as a discrete array of pixel values λ(x,y). The projections can be represented by sinograms p(r,φ) or by linograms, denoted g₀(u,v) in the angle range of −π/4≦θ<π/4, and g₁(u,v) in the range of π/4≦θ<3π/4, as disclosed by P. R. Edholm, “The linogram algorithm and direct Fourier method with linograms,” ULI-RAD-R-065, Linköping University, Sweden, January 1991. For the case of g₀(u,v), a relation between the two coordinate systems is:

r=u cos φ, (1a) and

v=tan φ. (2a)

In the case of g₁(u,v), a relation between the two coordinate systems is:

r=u sin φ, (1b) and

v=cot φ. (2b)

It is well known that linogram representation of tomographic measurements have been used as an alternative to sinograms. Linograms have been discussed in the scientific literature as early as 1987. One published method known as Approximate Discrete Radon Transform (ADRT) is used to rapidly create forward projections of digital images using the linogram representation. See, for example, Brady, M. L., “A Fast Discrete Approximation Algorithm for the Radon Transform,” SIAM J. Comp., Vol. 27, No. 1, 107-119 (February 1998). Brady teaches that ADRT can be used for back projection as well. This method has a computational speed advantage similar to that of the well known Fast Fourier Transform. However, ADRT has the disadvantage of using an inaccurate interpolation method known as the nearest-neighbor method. It has been pointed out that such interpolation is not adequate for image reconstruction in X-ray Computed Tomography (CT).

Another method used in statistical image reconstruction is the Maximum-Likelihood Expectation-Maximization (ML-EM) method. The ML-EM method is widely used. Published observations about the importance of “matching” the forward and backward projections using the ML-EM method indicated that when unmatched projectors are used, artifacts can result. However, others have observed that it is sometimes allowable to use unmatched projectors.

Shepp, L. A., and Y. Vardi, “Maximum likelihood reconstruction for emission tomography,” IEEE Trans Med Im, vol. MI-1, no 2, 113-122, October 1982, disclose the use of ML-EM in emission tomography. The Shepp and Vardi approach requires use of the same transfer function for forward and backward projection. Specifically, the two projectors should be matched exactly. Brady, id., pointed out that back projection can be achieved with the same algorithm used for forward projection, taking advantage of a symmetry of the linogram transformation that was noticed earlier by Edholm, id.

A primary drawback for using the ML-EM method is that it is relatively slow. The ML-EM method uses an iterative algorithm which requires, in principle, an infinite number of cycles, or iterations, to converge to the answer. In practical use of ML-EM, approximations are made in order to accelerate the calculation. One common approximation is the ordered-subsets version of the ML-EM method, or OSEM. Another common approximation includes stopping the iterations early.

### BRIEF SUMMARY OF THE INVENTION

The present invention is a method for performing accurate iterative reconstruction of image data sets based on Approximate Discrete Radon Transformation (ADRT). The present invention incorporates ADRT and its inverse to provide matched forward and backward projectors suitable for the Maximum-Likelihood Expectation-Maximization (ML-EM) reconstruction in PET. The present invention includes variations on this method including, but not limited to, iterative methods other than Expectation-Maximization (EM), and extensions to three-dimensional data processing.

The present invention utilizes a computing device which includes a processor used to perform various of the steps of the present method. At least one memory unit is provided for selectively storing data. The method is used to transform an input data set, or projection, into an output data set, or image. Both the input and output data sets are stored in the memory unit as large arrays of numbers. Input and output data sets are input to and output from the memory unit via an input/output (I/O) device. A set of calibration factors is also stored within the memory unit, the calibration factors being input via the I/O device, as well.

A two-dimensional EM (2D EM) reconstruction algorithm is controlled by the processor. The 2D EM algorithm is driven by a linogram L_{u,v} of size 3N×(2N−4), where N is a power of 2. The 2D EM algorithm performs the following straightforward steps. An estimation matrix of size N×N is initialized to the value 1.0 in all pixels. A back projection of the projection weights is then formed. If required, normalization and attenuation-weighting are included in the reconstruction in order to achieve a different image quality. Next, a loop is begun over iterations i. The estimate is then forward projected into linogram coordinates. A correction ratio is formed in all linogram bins (u,v). The correction factors are then back projected and a normalization factor is applied. Finally, the loop is closed over the specified number of iterations.

The present invention further provides for the extension of the above-described 2D EM method into three dimensional (3D) reconstructions. This method uses 3D PET lines of response which have been histogrammed in sinogram or planogram format and converted to 2D lines of response using conventional methods. Forward projection is performed on planes extracted from the volume of image voxels. The image voxels are manipulated with the normal ADRT algorithm. Back projection is also performed in 2D planes, which are subsequently added into the 3D array with the correct orientations.

Using ADRT, half-images are defined with a number of columns N_{X}, and a number of rows N_{Y}=2^{P}, which is by definition a power of 2, and equals one half the size of the full image. The number of columns N_{X}, is twice the number of rows N_{Y}, or N_{X}=2N_{Y}. Forward projection of a half-image I(x,y) at angles between 0 and π/4 radians is accomplished by first defining two image buffers, R, with (N_{X}+N_{Y}) columns and N_{Y} rows. One image buffer is identified as the “current” and one as the “previous” image buffer. Image values are loaded into the left columns of the “previous” buffer, leaving the rightmost Nₓ columns empty. At the end, one quarter of a complete linogram, representing the angle range from 0 to 45 degrees, is extracted from the buffer.

After the loops have been executed, array columns correspond to the u-coordinate of the linogram, and rows correspond to the v-coordinate. The linogram bin size (u-spacing) equals the spacing of pixels in the original half image. There are N_{Y} samples of the v-coordinate, regularly spaced between 0 and 1, which corresponds to the angle range from 0 to π/4 radians.

The present invention is provided further to perform maximum-likelihood expectation maximization (ML-EM) reconstructions using the same transfer function for backward projection as for forward projection. The forward and backward projectors are matched by reversing the method of the forward projection.

In order to accomplish the back projection portion of the reconstruction, the partial linogram is first placed in the R array. The loops are identical to those described above, except that the outermost loop begins with i=p and descends to i=1. Instead of adding two values in the innermost loop, one value is added into each of the corresponding destination locations. After looping, the back-projected half-image is extracted from the R array.

The ADRT method outlined above is applied eight times to perform the approximate linogram transformation on a square, N×N image array, where N is a power of 2. To generate g₀(u,v), the algorithm is applied to the top and bottom halves of the image, before and after reversing the columns to generate results for negative angles. To generate g₁, it is applied to the right and left halves of the image before and after reversing the rows. Back projection uses the same partitioning scheme. The row indexed by N/2, slightly off the exact center, and the column indexed by N/2, also off center, represent the symmetry axis of the ADRT. The u-intercept is defined on the ARDT symmetry axis and is normally projected twice. In the second application the contents are zeroed before forward projection. The leftmost column and the bottommost row are not used.

In comparison with other projection methods, ADRT runs very fast. It is accelerated by the same reordering technique that makes fast Fourier transforms run fast. Like the FFT, the ADRT has a butterfly architecture so that the inner loops are called fewer times than in standard ray-driven or pixel-driven forward projection. ADRT is also fast because the operation in the innermost loop is a simple addition.

The method of the present invention is applicable to various other iterative procedures which meet several criteria. The iterative procedure must start with an initial estimate of the image. The current estimate is then forward-projected into linogram coordinates using the ADRT method. The comparison of the forward-projected linogram with measured input values results in a new linogram of correction values. The linogram of correction values is then back projected into image coordinates, using the ADRT back projection of the present method. The comparison of back projected pixel values to values in the previous estimate results in a new image estimate. A stopping rule is evaluated. If the rule is not satisfied, the algorithm returns to the first step. Otherwise, the image values are set to those of the current estimate. The image values may then be accepted as a final image, or may be modified, for example, by applying a spatial filter. The algorithm is then terminated.

3D images may be formed using the 2D algorithm as described, by one of several well known methods. Starting with a set of 2D linograms derived by one of several methods, 2D reconstruction is followed by a computation in which the image planes are interpolated into a volume. Post-processing computation is then performed as an optional final step.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a schematic diagram of the device provided for performing the method of the present invention;

FIGS. 2A-2G illustrate the results of ADRT forward projection of an object having 128 columns and 64 rows;

FIGS. 3A-3D illustrate image partitioning used in the ADRT method incorporated in the present invention, showing a simple case with eight rows and eight columns of pixels;

FIGS. 4A-4B illustrate a linogram and an EM-ADRT image from a positioning accuracy and count preservation test of results from the method of the present invention;

FIGS. 5A-5E illustrate the results of a Monte-Carlo investigation of the method of the present invention; and

FIGS. 6A-6B illustrate anterior maximum-intensity projection images (MIP) from the clinical study using the method of the present invention.

### DETAILED DESCRIPTION OF THE INVENTION

A method for performing accurate iterative reconstruction of image data sets based on Approximate Discrete Radon Transformation (ADRT) is disclosed. ADRT incorporates a fast butterfly algorithm. The present invention incorporates an iterative algorithm based on ADRT forward and backward projectors. More specifically, the present invention incorporates ADRT and its inverse to provide matched forward and backward projectors suitable for the Maximum-Likelihood Expectation-Maximization (ML-EM) reconstruction in PET. Performing ML-EM iterations with the extremely fast ADRT method in the present invention is hereinafter referred to as EM-ADRT. The present invention includes variations on this method including, but not limited to, iterative methods other than Expectation-Maximization (EM), and extensions to three-dimensional data processing. The present invention provides for iterative PET reconstruction of good quality images in a short period of time.

Several advantages of the present invention are realized when compared to prior art methods. Namely, the present invention allows for iterative ML-EM reconstructions to be performed as fast as ordered subsets ML-EM (OSEM) without making the ordered-subsets approximation. Further, the time required to run various other two-dimensional iterative reconstructions that require forward projection and back projection is significantly reduced. Also, reconstructions by ML-EM are accelerated by large factors in the case of three-dimensional data sets.

While the present invention is primarily described for use with Positron Emission Tomography (PET), it will be understood that the method of the present invention is useful with other imaging modalities.

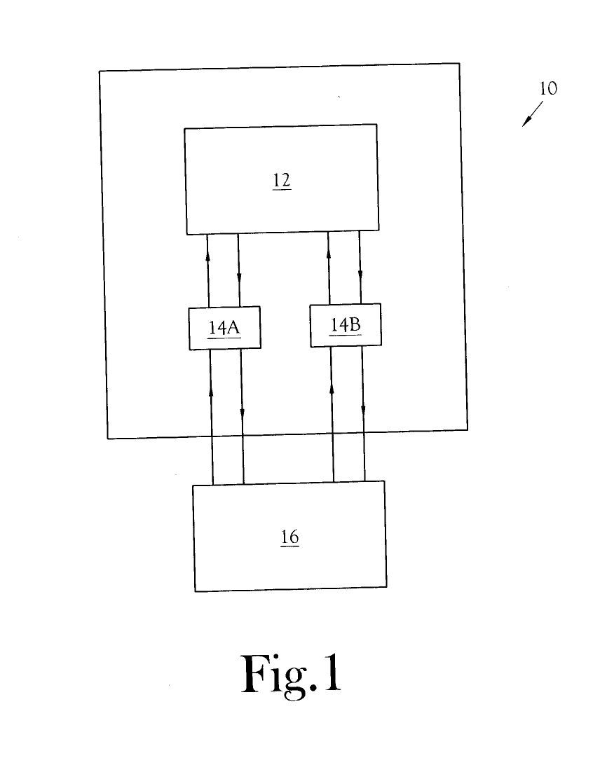

As illustrated in FIG. 1, the present invention utilizes a computing device 10 such as a digital computer, a cluster or network of computers, or a device comprised of field-programmable gate arrays (FPGA). The computing device 10 includes a processor 12 used to perform various of the steps of the present method. At least one memory unit 14 is provided for selectively storing data. Illustrated are two memory units 14A and 14B. However, it will be understood by those skilled in the art that more or fewer memory units 14 may be effectively implemented. The method is used to transform an input data set, or projection, into an output data set, or image. Both the input and output data sets are stored in the memory unit 14A as large arrays of numbers. Input and output data sets are input to and output from the memory unit 14A via an input/output (I/O) device 16. For purposes of the present invention, the I/O device 16 is any conventional device, system or network provided for input and output of data. A set of calibration factors is also stored within the memory unit 14B, the calibration factors being input via the I/O device 16, as well. The method of the present invention is driven in part by the set of calibration factors.

A two-dimensional EM (2D EM) reconstruction algorithm has been developed to be controlled by the processor 12. The 2D EM algorithm is driven by a linogram L_{u,v} of size 3N×(2N−4), where N is a power of 2. The 2D EM algorithm performs the following straightforward steps. Each pixel in the matrix of size N×N is given an initial value. Pixel values (x,y) are denoted in iteration i by the symbol

$${λ}_{x , y}^{i} .$$

A reciprocal back projection of the projection weights is then formed from the following equation:

$${B}_{x , y} = \frac{1}{{A}^{T} \{ \frac{1}{1 + {v}^{2}} \}}$$

where A^{T} is an adjoint ADRT projector, or back projector of the ADRT, and B_{x,y} is referred to as the normalization image. Those skilled in the art of image reconstruction will understand that, by modifying this equation, normalization and attenuation-weighting can be included in the reconstruction in order to achieve a better image quality. Accordingly, it will be understood that the present invention is not intended to be limited to the specific equations and/or algorithms herein disclosed.

Next, a loop is begun over iterations i. The estimate is then forward projected into linogram coordinates using the equation:

$${P}_{u , v}^{i} = A \{ {λ}_{x , y}^{i} \}$$

where A is the ADRT forward projector.

In all linogram bins (u,v) the correction ratio:

$${C}_{u , v} = \{ \begin{matrix}\frac{{L}_{u , v}}{{P}_{u , v}^{i}} & if {P}_{u , v}^{i} exceeds the value ϵ \\ 0 & otherwise \end{matrix}$$

is formed. In this equation, ε is a small constant value.

The correction factors are back projected and the normalization image is applied, as in the following equation:

$${λ}_{x , y}^{i + 1} = {λ}_{x , y}^{i} {B}_{x , y} {A}^{T} \{ {C}_{u , v} \}$$

Finally, the loop described above is closed. Specifically, after the correction factors are back projected and the normalization image is applied, the method returns to the step of back projecting the projection weights.

The algorithm described above provides several advantages over prior art iterative reconstructions. Specifically, the forward projection and back projection require an order of N² log N operations rather than N³ operations. Therefore the approach is intrinsically fast, and different from other approaches which require multiplication by interpolation coefficients. Further, each step in the forward projection innermost loop requires only one addition and one store operation. Back projection requires two add into memory operations. These operations are intrinsically fast. In addition, the forward and backward projectors are matched.

A feature of the present 2D EM algorithm is the rigid relationship between the number of image rows and columns N, and the number of angles. This relationship is quantified as (N_{φ}=2N−4).

Another distinguishing feature compared to the prior art methods is the use of nearest neighbor interpolation. While the approximate nature of this interpolation has been a concern to researchers trying to apply the method in X-ray CT work, the artifacts observed in CT are not as significant a concern with PET reconstructions. To this extent, it is worthwhile also to note that CT reconstructions have not been based on an EM algorithm. While nearest neighbor interpolation is a concern in some imaging modalities, results indicate that the resolution lost in nearest-neighbor interpolation is compensated by the strict matching of forward and backward projection.

Further, in the present invention. OSEM algorithms are not possible, as all angles are used simultaneously.

The present invention further provides for the extension of the above-described 2D EM method into three dimensional (3D) reconstructions. This method uses 3D PET lines of response 18 which have been histogrammed in planogram format and converted into 2D lines of response using conventional methods. Forward projection is performed on planes extracted from the volume of image voxels, which are manipulated with the normal ADRT algorithm. Back projection is also performed in 2D planes, which are subsequently added into the 3D array with the correct orientations.

As discussed above, the present invention incorporates forward and backward ADRT. Half-images are defined with a number of columns N_{X}, and a number of rows N_{Y}=2^{P}, which is by definition a power of 2, and equals one half the size of the full image. The number of columns N_{X} is twice the number of rows N_{Y}, or N_{X}=2N_{Y}.

Forward projection of a half-image I(x,y) at angles between 0 and π/4 radians is accomplished as follows. Two image buffers, R, with (N_{X}+N_{Y}) columns and N_{Y} rows are defined. The additional columns are needed because, although the linogram projection of rectangular space spans only N_{X} bins at zero degrees, an additional N_{Y} bins are needed for the projection at angles up to π/4 radians. One is identified as the “current” and one as the “previous” version of the buffer. Image values are loaded into the left columns of the “previous” buffer, leaving the rightmost N_{X} columns empty. A simplified description of the ADRT method of the present invention is as follows:

for i = 1 to p {

for a = 0 to (2ⁱ − 1) {

a₁ = └a/2.0┘, a₂ = ┌a/2.0┐
for y = 0 to N_{y} − 2ⁱ step 2ⁱ {

for all x,

R^{cur} (x,y + a) = R^{prev} (x,y + a₁) + R^{prev} (x − a₂,y + 2ⁱ⁻¹ + a₁)

}

}
let R^{prev} equal R^{cur}

}

At the end, one quarter of a complete linogram, representing the angle range from 0 to 45 degrees, is extracted from the buffer. The symbols └ ┘ and ┌ ┐ represent floor and ceil functions.

After the loops have been executed, array columns correspond to the u-coordinate of the linogram, and rows correspond to the v-coordinate. The linogram bin size (u-spacing) equals the spacing of pixels in the original half image. There are N_{Y} samples of the v-coordinate, regularly spaced between 0 and 1, which corresponds to the angle range from 0 to π/4 radians.

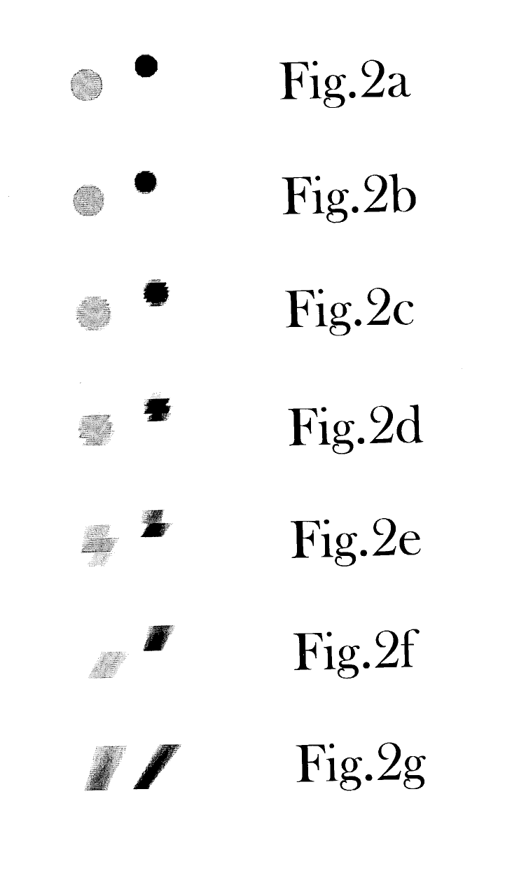

The results of this ADRT forward projection are illustrated in FIGS. 2A-2G. FIG. 2A illustrates an object having 128 columns and 64 rows. In prior art methods, projection of this object into 64 angle bins requires 64 steps for each pixel in the matrix. FIG. 2B illustrates a first pass of the forward projection combining row and column displacements of 0 and 1. FIGS. 2C-2F illustrate the second through the fifth passes. FIG. 2G is an illustration, after the sixth and final pass, of the linogram generated for angles between 0 and 45 degrees.

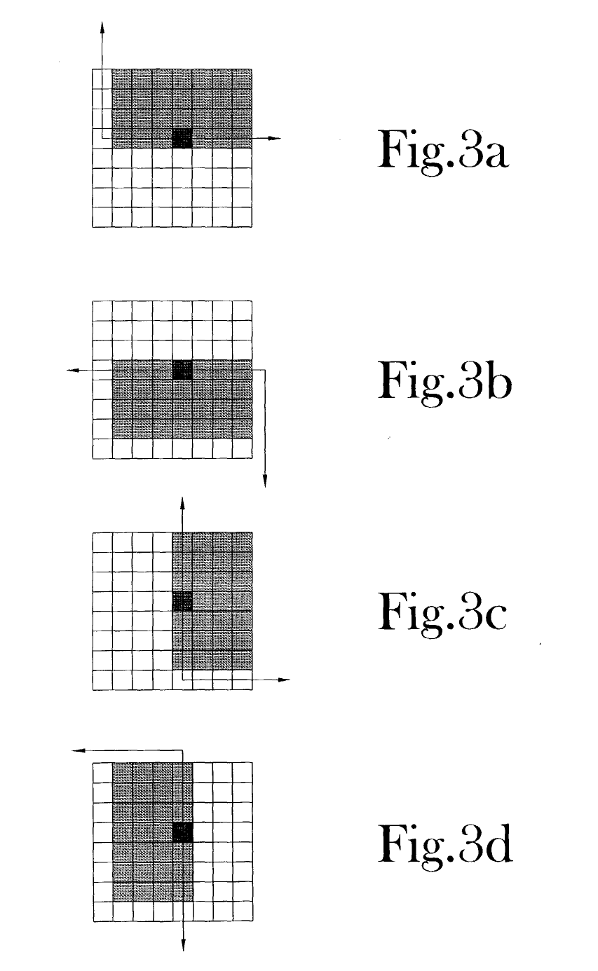

The ADRT method outlined above is applied eight times to perform the approximate linogram transformation on a square, N×N image array, where N is a power of 2. To generate g₀(u,v), the algorithm is applied to the top and bottom halves of the image, before and after reversing the columns to generate results for negative angles. To generate g₁, it is applied to the right and left halves of the image before and after reversing the rows. Back projection, discussed below, uses the same partitioning scheme. The row indexed by N/2, slightly off the exact center, and the column indexed by N/2, also off center, represent the symmetry axis of the ADRT. The u-intercept is defined on the ARDT symmetry axis and is normally projected twice. For this reason, in the second application the contents are zeroed before forward projection. The leftmost column and the bottommost row are not used. The partitioning into half images is illustrated in FIGS. 3A-3D. The image is divided into top and bottom halves (FIGS. 3A and 3B, respectively) for projection to or from g₀(u,v), and into right and left halves (FIGS. 3C and 3D, respectively) for g₁(u,v). This is illustrated by a simple case with eight rows and eight columns. Light-gray shading shows a half-array which can be projected by ADRT. Dark-gray shading shows the defined central pixel.

The exactly matched back projector associated with the above forward projector is as follows:

for i = p to 1 step − 1{

zero all values R^{cur}(x,y)
for a = 0 to (2ⁱ − 1) {

a₁ = └a/2.0┘, a₂ = ┌a/2.0┐
for y = 0 to N_{Y} − 2ⁱ step 2ⁱ {

for all x, {

R^{cur} (x,y + a₁) = R^{cur} (x,y + a₁) + R^{prev} (x,y + a)

R^{cur}(x − a₂,y + 2ⁱ⁻¹ + a₁) = R^{cur} (x − a₂,y + 2ⁱ⁻¹ + a₁) + R^{prev} (x,y + a)

}

}

}
let R^{prev} equal R^{cur}

}

First, the partial linogram is placed in the R array. All u values are used. However, only the v values between 0 and 1 are used. The loops are identical to those described above, except that the outermost loop begins with i=p and descends to i=1. Instead of adding two values in the innermost loop, one value is added into each of the corresponding destination locations. After looping, the back-projected half-image is extracted from the R array.

It will be understood by those skilled in the art that this description of the ADRT method used in association with the present invention is only illustrative thereof and may be modified as required to achieve similar results.

The ML-EM algorithm is implemented with the forward projections and back projections being performed with ADRT. The initial image λ(x,y) is a square array with all pixel values assigned an initial value. The algorithm cycles through forward projection, comparison with projections, and back projection with the following update equation:

$${λ}^{new} = \frac{{λ}^{old}}{B \{ n \}} B \{ \frac{g}{max ( F \{ {λ}^{old} \} , ϵ} \} .$$

In this equation, g is the linogram, F is ADRT forward projection, B is an exactly matched ADRT back projection, n is the linogram normalization factor, and ε is a smallness parameter whose presence in the equation protects against division by zero. In the present invention, a value of ε=1×10⁻¹⁰ has been used.

Because the projector is based on nearest-neighbor interpolation, the accuracy of the EM-ADRT reconstruction algorithm incorporated in the present invention was investigated. Several tests were performed, including tests for: speed of iterative reconstruction; positioning accuracy; quantitative accuracy; and qualitative image appearance in clinical conditions.

In all comparisons of sinogram-based results to linogram-based results, the width of the linogram u-bins was set equal to the width of the sinogram bins, which requires twice the number of linogram u-bins as sinogram r-bins. The computer used for all tests was a PC with dual 1.7-GHz Pentium-IV processors, running Red Hat Linux 7.2. Only one thread of execution was used, so the performance was essentially that of a single CPU. The projection software was coded in ANSI C compiled with gcc, while the update was implemented in vectorized IDL. This combination of C and IDL was also used in ordered-subsets MLEM software (OSEM).

Computation speed was first tested at the component level by measuring execution times of the forward projector and the back projector for images of size 128×128 and 256×256. The linogram dimensions in the two cases were 256×252 and 512×508. Sixteen (16) iterations of an iterative reconstruction were executed. Performance was compared to sinogram-based OSEM with two (2) iterations and eight (8) subsets. Sinogram dimensions of 128×128 and 256×256 were used for the two cases. The performance of sinogram-based ML-EM was also evaluated with an OSEM code, with the number of subsets equal to 1.

Forward ADRT projection of a 128×128 matrix into a 256×252 linogram ran in 0.0066 sec. Back projection ran in 0.0082 sec. When the matrix size was 256×256 and the linogram size was 512×508, the forward projection time was 0.046 sec and the back projection time was 0.063 sec. Sixteen (16) iterations of EM-ADRT ran in 0.32 sec for the 128×128 matrix with 252 v-bins, and in 2.0 see for the 256×256 matrix with 508 v-bins. The sinogram-based OSEM calculation ran in 0.28 sec for the 128×128 matrix and in 3.3 sec for the 256×256 matrix. The sinogram-based EM calculation ran in 1.72 sec for the 128×128 matrix and in 13 sec for the 256×256 matrix.

With respect to execution speed, the ADRT forward projector was somewhat faster than the matched back projector. At least three fourths (3/4) of the EM-ADRT reconstruction time is devoted to calculating forward and backward projection values. In the speed-of-execution comparison with OSEM, the number of ordered subsets was fixed at eight (8). With this constraint, it was found that EM-ADRT accelerates reconstruction by about the same factor as OSEM. Speed comparisons between sinogram-based OSEM and other reconstruction methods are complicated by the tendency in an OSEM reconstruction to converge faster as the number of subsets is increased, counterbalanced by a decline in execution speed based on the need to hold in the computer memory a large number of matrices B(n), one for each subset, for the division indicated in the equation above. The OSEM code used runs fast because it orders the arrays in dynamic memory to make good use of the processor memory cache and efficiently reuses interpolation coefficients whose calculation is time-consuming. The intrinsic speed advantage of the EM-ADRT algorithm, on the other hand, is derived from its butterfly architecture and these reconstructions are done one plane at a time. Depending on matrix dimensions and the configuration of the computer, the processor in some circumstances is capable of holding an entire half-image and a quarter-linogram in its memory cache. In this situation, the method of the present invention is performed considerably faster.

The next two tests used mathematical phantoms. To evaluate positioning accuracy, count preservation, and resolution, an object was defined consisting of a centered disc of diameter 34.4 pixels and eight Gaussian blobs with full widths at half maximum (FWHM) of 2.0, 2.5, 3.0, 3.5, 4.0, 5.0, 6.0, and 7.0 pixels. A sampled linogram with 256 u-bins and 508 v-bins was generated by analytically integrating the shapes along the lines of response. The ADRT algorithm was performed through 20 iterations. Each Gaussian blob in the reconstructed image was isolated for analysis. For each region the area, centroid location, and FWHM were compared with the parent Gaussian function.

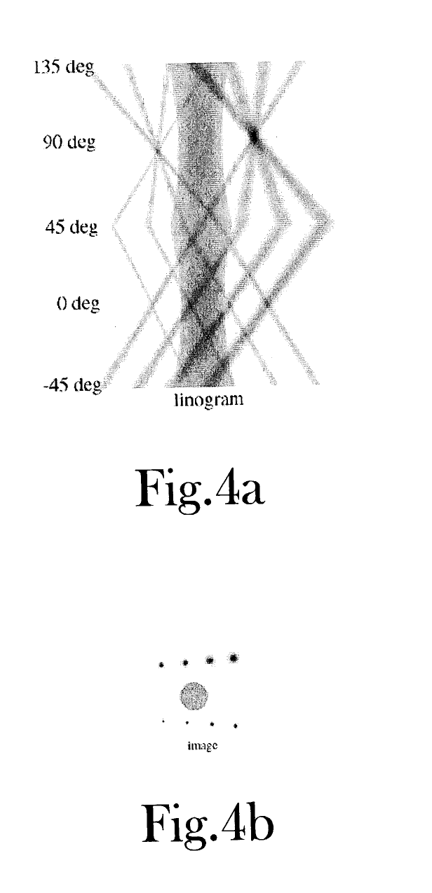

The linogram and the EM-ADRT image from the test of positioning accuracy and count preservation are shown in FIGS. 4A and 4B, respectively. The centers of gravity were found to be at the correct (x,y) coordinates with a worst-case deviation of 0.04 pixels. The counts in each reconstructed blob had the correct values, with discrepancies of 1.8% or less. The resolution of the reconstructed blobs was slightly degraded in every case, except that of the 7-mm blob where the FWHM after reconstruction was slightly less than that of the parent Gaussian. After reconstruction the blob with 2.00-pixel FWHM was blurred to 2.18 pixels; the 2.50-pixel blob was blurred to 2.74 pixels; the 3.00-pixel blob was blurred to 3.31 pixels; the 4.00-pixel blob was blurred to 4.04 pixels. After 20 iterations, the reconstruction of the centered disc was quantitatively accurate, flat, and smooth, with 1% root-mean-square deviation from flatness. When more iterations were performed, up to 1000, reconstructions of the disc did not show signs of a “ringing” Gibbs artifact at the edge, which is typically seen with many other reconstruction techniques.

Brady, id., noted that ADRT's forward projector uses a succession of nearest-neighbor interpolations to calculate Radon-transform integrals in which mispositioning on the u-axis is never worse than 1/6log₂N pixels, and is usually better than this. In the case of a 256×256 image matrix with 2.2 mm pixels, the worst case mispositioning as described by Brady is therefore 2.6 mm. The mispositioning is much less than this on most lines of response. Testing of the present invention has shown that ADRT is well suited to iterative ML-EM PET reconstruction with matched forward and backward projectors. As shown above, the EM-ADRT reconstruction placed Gaussian blobs in the correct place with no worse than 0.04 pixels mispositioning, with counts being preserved locally and globally. After 20 iterations, the blob images were only a few tenths of a pixel broader than the objects themselves, and after each successive iteration, the images sharpened further.

To look for differences between the linogram-based EM-ADRT and sinogram-based OSEM and ML-EM algorithms, a Monte-Carlo simulation of a mathematical phantom that assumed an ideal instrument with no resolution degradation and no attenuation was performed. A background object 21 cm in diameter filled with radioactivity was defined. In this object six circular regions of different diameters were defined. Four of the regions were “hot” with four times the specific activity of the background. These objects had diameters of 1.0, 1.3, 1.7, and 2.2 cm and were surrounded by circular walls having a thickness of 0.1 cm with no activity. Cold regions with diameters of 2.9 and 3.9 cm were also defined. A total of events were simulated and binned into a 256×256 sinogram and a 512×208 linogram. The u- and r-bin sizes were 0.22 cm. The linogram was reconstructed with 64 iterations of EM-ADRT. The sinogram was reconstructed with filtered back projection and OSEM (4 iterations, 16 subsets.)

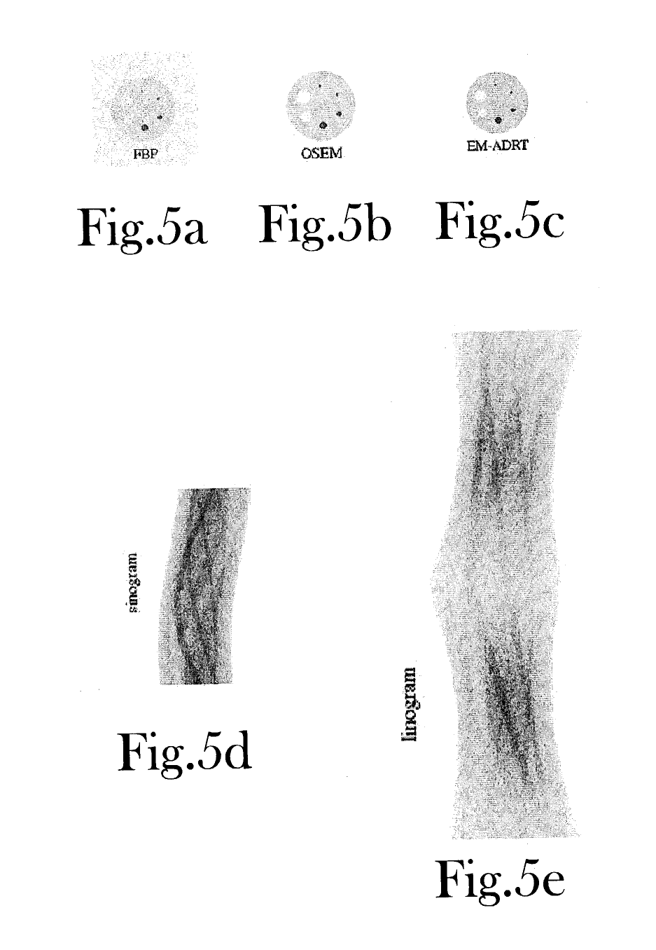

FIGS. 5A-5E illustrate the results of the Monte-Carlo investigation. FIGS. 5A-5C, respectively, represent a forward and back projection reconstruction; an OSEM reconstruction; and an EM-ARDT reconstruction. Finally, FIGS. 5D and 5E represent a sinogram and a linogram, respectively, from the Monte-Carlo investigation. All structures are visible in each reconstruction.

Finally, a clinical whole-body data set was considered. A 70 year-old male, 175 cm tall and weighing 82 kg, was injected with 400 MBq of fluorine-18 fluorodeoxyglucose. A 20-minute whole-body scan was performed 3 hours post-injection using a fully 3D PET tomograph with five revolving panel detectors, a 52.5 cm axial field of view, and 33 cm overlap between the two bed positions. The 3D emission sinograms from this patient were corrected for scatter and attenuation, then Fourier rebinned (FORE) into 257 planes of 2D sinograms. The 2D sinograms were attenuated and reconstructed with 2 iterations, 8 subsets of attenuation-weighted OSEM. The attenuated sinograms were interpolated into a 512×508 linogram. The sinograms of attenuation values were also interpolated into linograms of attenuation coefficients. A 16-iteration attenuation-weighted EM-ADRT reconstruction of the linograms was performed. After reconstruction, both image volumes were smoothed with an isotropic three-dimensional Gaussian filter with 0.6 mm FWHM.

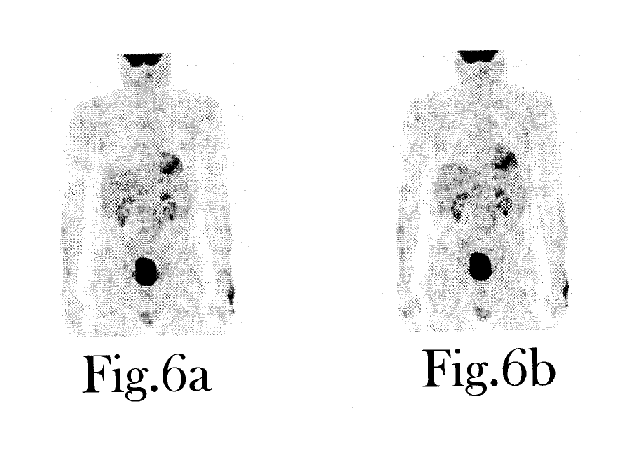

FIGS. 6A and 6B present anterior maximum-intensity projection images (MIP) from the clinical study. FIG. 6A is an MIP image from a sinogram-based OSEM reconstruction. FIG. 6B is an MIP image from the linogram-based EM-ADRT reconstruction of the present invention. The images show the same lesions, although they are not identical. A volumetric comparison of the three-dimensional images shows no striking differences between the two studies.

In comparison with other projection methods, ADRT runs very fast. It is accelerated by the same reordering technique that makes fast Fourier transforms run fast. Like the FFT, the ADRT has a butterfly architecture so that the inner loops are called fewer times than in standard ray-driven or pixel-driven forward projection. ADRT is also fast because the operation in the innermost loop is a simple addition.

While the present invention has been described in association with a single iterative technique (ML-EM), it will be understood that the method of the present invention is applicable to various other iterative procedures which meet several criteria. The iterative procedure must start with an initial estimate of the image. The current estimate is then forward-projected into linogram coordinates using the ADRT method. The comparison of the forward-projected linogram with measured input values results in a new linogram of correction values. The linogram of correction values is then back projected into image coordinates, using the ADRT back projection of the present method. The comparison of back projected pixel values to values in the previous estimate results in a new image estimate. A stopping rule is evaluated. If the rule is not satisfied, the algorithm returns to the first step. Otherwise, the image values are set to those of the current estimate. The image values may then be accepted as a final image, or may be modified. The algorithm is then terminated.

3D images may be formed using the 2D algorithm as described, by one of several well known methods. One well known method uses a set of 2D acquired linograms, with one 2D linogram for each plane. Another starts with a 3D PET data set. A set of 2D linograms is derived by using the single-slice rebinning method (SSRB) or by working with the direct segment only. Another starts with a 3D PET data set, and a set of 2D linograms is derived by using the Fourier rebinning method (FORE.) With either of these methods, the 2D reconstruction is followed by a computation in which the image planes are interpolated into a volume. That step is followed by a post-processing computation. While several 3D extensions have been particularized herein, it will be understood that the present invention is not intended to be limited by these extensions.

From the foregoing description, it will be recognized by those skilled in the art that a method for reconstructing image data sets having advantages over the prior art has been disclosed. The present invention provides for the use of the forward-projection algorithm taught by Brady, as well as reversing the order of the loops of the algorithm to create a back projector which exactly matches the forward projector. In one implementation, this method (EM-ARDT) incorporating matched set of projectors is useful in performing ML-EM reconstructions on PET data sets. The method of the present invention works naturally with data acquired in a linogram representation of the projection values. The EM-ARDT method of the present invention runs approximately one order of magnitude faster than ordinary ML-EM on data sets of similar size, and generates accurate reconstructed images.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. A method for performing accurate iterative reconstruction of an image data set defining rows and columns of data, said method utilizing a computing device having a processor, at least one memory unit and an input/output (I/O) device, said method including the steps of:
a) forming forward projections in a linogram representation using an Approximate Discrete Radon Transform (ADRT) method; and
b) forming back projections in a linogram representation using said ADRT method.

2. The method of claim 1 before said step of forming forward projections, further including the steps of:
projecting an upper set and a lower set of said image rows separately into and from a first half of said linogram representation; and
projecting a left set and a right set of said image columns separately into and from a second half of said linogram representation.

3. The method of claim 1 wherein said step of forming back projections is accomplished using a back projector which exactly matches a forward projector used to accomplish said step of forming forward projections, said ADRT method including an outer loop operating in reverse order in said step of forming back projections in relation to said step of forming forward projections.

4. The method of claim 1 wherein said image data set is acquired in Positron Emission Tomography (PET).

5. A method for performing accurate iterative reconstruction of an image data set by the Maximum-Likelihood Expectation-Maximization (ML-EM) method, said method being performed with a computing device having a processor, at least one memory unit and an input/output (I/O) device, said method including the steps of:
a) initializing an estimation image of size N×N pixels to an initial value in all said pixels;
b) forming back projection of projection weights;
c) beginning a loop is over i iterations;
d) forward projecting pixel coordinates into linogram coordinates using an Approximate Discrete Radon Transform (ADRT) method;
e) forming a correction factor in all said linogram coordinates;
f) back projecting said correction factors using said ADRT method;
g) applying a normalization factor; and
h) repeating said steps of back projecting said correction factors and applying a normalization factor through said i iterations until a stopping criterion is satisfied.

6. The method of claim 5 wherein said step of forming back projection of projection weights is accomplished by the equation:
$${B}_{x , y} = \frac{1}{{A}^{T} \{ \frac{1}{1 + {v}^{2}} \}}$$
where A^{T} is an ADRT back projector.

7. The method of claim 6 wherein said step of forward projecting said pixel coordinates into linogram coordinates is accomplished using the equation:
$${P}_{u , v}^{i} = A \{ {λ}_{x , y}^{i} \}$$
where A is an ADRT forward projector.

8. The method of claim 7 wherein said step of forming a correction ratio in all said linogram coordinates is accomplished using the equation:
$${C}_{u , v} = \frac{{L}_{u , v}}{{P}_{u , v}^{i}}$$
where
$${P}_{u , v}^{i}$$
exceeds a preset value, and the equation:
C_{u,v}=0
where
$${P}_{u , v}^{i}$$
does not exceed said preset value.

9. The method of claim 8 wherein said step of applying a normalization factor is accomplished using the equation:
$${λ}_{x , y}^{i + 1} = {λ}_{x , y}^{i} {B}_{x , y} {A}^{T} \{ {C}_{u , v} \}$$
where
$${λ}_{x , y}^{i}$$
represents the pixel value at coordinates (x,y) through iteration i, and where
$${λ}_{x , y}^{i + 1}$$
represents the pixel value at coordinates (x,y) through iteration i+1.

10. The method of claim 5 wherein the image data set is a two-dimensional (2D) image data set and wherein 2D EM is incorporated.

11. The method of claim 5 wherein the image data set is a three-dimensional (3D) image data set comprised of a series of 2D linograms.

12. The method of claim 11 further comprising the step of post processing said volume.

13. The method of claim 5 wherein said image data set is a Positron Emission Tomography (PET) data set.

14. The method of claim 5 before said step of forming forward projections, further including the steps of:
projecting an upper set and a lower set of said image rows separately into and from a first half of said linogram representation; and
projecting a left set and a right set of said image columns separately into and from a second half of said linogram representation.

15. The method of claim 5 wherein said step of forming back projections is accomplished using a back projector which exactly matches a forward projector used to accomplish said step of forming forward projections, said ADRT method including an outer loop operating in reverse order in said step of forming back projections in relation to said step of forming forward projections.

16. A method for performing accurate iterative reconstruction of a Positron Emission Tomography (PET) data set, said method being performed with a computing device having a processor, at least one memory unit and an input/output (I/O) device, said method including the steps of:
i) initializing all pixels in an estimation image of size N×N pixels;
j) forming back projection of projection weights;
k) beginning a loop is over i iterations;
l) forward projecting pixel coordinates into linogram coordinates using an Approximate Discrete Radon Transform (ADRT) method;
m) forming a correction factor in all said linogram coordinates;
n) back projecting said correction factors using said ADRT method;
o) applying a normalization factor; and
p) repeating said steps of back projecting said correction factors and applying a normalization factor through said i iterations.

17. The method of claim 16 wherein said step of forming back projection of projection weights is accomplished by the equation:
$${B}_{x , y} = \frac{1}{{A}^{T} \{ \frac{1}{1 + {v}^{2}} \}}$$
where A^{T} is an ADRT back projector;
wherein said step of forward projecting said pixel coordinates into linogram coordinates is accomplished using the equation:
$${P}_{u , v}^{i} = A \{ {λ}_{x , y}^{i} \}$$
where A is an ADRT forward projector;
wherein said step of forming a correction ratio in all said linogram coordinates is accomplished using the equation:
$${C}_{u , v} = \frac{{L}_{u , v}}{{P}_{u , v}^{i}}$$
where
$${P}_{u , v}^{i}$$
exceeds a preset value, and the equation:
C_{u,v}=0
where
$${P}_{u , v}^{i}$$
does not exceed said preset value; and
wherein said step of applying a normalization factor is accomplished using the equation:
$${λ}_{x , y}^{i + 1} = {λ}_{x , y}^{i} {B}_{x , y} {A}^{T} \{ {C}_{u , v} \}$$
where
$${λ}_{x , y}^{i}$$
represents the pixel value at coordinates (x,y) through iteration i, and where
$${λ}_{x , y}^{i + 1}$$
represents the pixel value at coordinates (x,y) through iteration i+1.

18. The method of claim 16 wherein the image data set is a two-dimensional (2D) image data set and wherein 2D EM is incorporated.

19. The method of claim 16 wherein the image data set is a three-dimensional (3D) image data set comprised of a series of 2D linograms.

20. The method of claim 19 further comprising the step of post processing said volume.

21. The method of claim 16 wherein said step of forward projecting pixel coordinates into linogram coordinates using an Approximate Discrete Radon Transform (ADRT) method includes the steps of:
i) defining half-images I(x,y) with a number of columns N_{X} and a number of rows N_{Y}=2^{P}, which is by definition a power of 2, wherein N_{X}=½N_{Y};
ii) defining a current image buffer, R_{C}, with (N_{X}+N_{Y}) columns and N_{Y} rows;
iii) defining a previous image buffer, R_{P}, with (N_{X}+N_{Y}) columns and N_{Y} rows;
iv) loading image values into said previous buffer using the method defined by:
for i = 1 to p step 1{
for a = 0 to (2ⁱ − 1) {
a₁ = └a/2.0┘, a₂ = ┌a/2.0┐
for y = 0 to N_{Y} − 2ⁱ step 2ⁱ {
for all x,
R^{cur} (x,y + a) = R^{prev} (x,y + a₁) + R^{prev} (x − a₂,y + 2ⁱ⁻¹ + a₁)
}
}
let R^{prev} equal R^{cur}
}
v) extracting one quarter of a complete linogram, representing a 45° range; and
vi) repeating said step of loading image values through four separate angle ranges and two said half-images to accomplish forward projection of the entire of said image.

22. The method of claim 16 wherein said step of back projecting said correction factors using said ADRT method includes the steps of:
i) loading image values into said previous buffer using the method defined by:
for i = p to 1 step − 1{
zero all values R^{cur} (x,y)
for a = 0 to (2ⁱ − 1) {
a₁ = └a/2.0┘, a₂ = ┌a/2.0┐
for y = 0 to N_{Y} − 2ⁱ step 2ⁱ {
for all x, {
R^{cur} (x,y + a₁) = R^{cur} (x,y + a₁) + R^{prev} (x,y + a)
R^{cur} (x − a₂,y + 2ⁱ⁻¹ + a₁) = R^{cur} (x − a₂,y + 2ⁱ⁻¹ + a₁) + R^{prev} (x,y + a)
}
}
}
let R^{prev} equal R^{cur}
}
and
ii) extracting one quarter of a complete linogram, representing a 45° range.
